(19) United States
(12) Patent Application Publication
(10) Pub. No.: US 2002/0087625 A1
(43) Pub. Date: Jul. 4, 2002

(54) Sharing user profiles between processor-based systems

(76) Inventors: Kim Toll, Hillsboro, OR (US); David A. Sandage, Forest Grove, OR (US)

Correspondence Address: Timothy N. Trop, TROP, PRUNER & HU, P.C., STE 100, 8554 KATY FWY, HOUSTON, TX, 77024-1805, US

(21) Appl. No.: 09/754,556

(22) Filed: Jan. 4, 2001

(51) Int. Cl. G06F 15/16; G09G 5/00

(52) U.S. Cl. 709/203; 345/745

(57) ABSTRACT

A plurality of users may have their user profiles or environments stored on a first processor-based system. When they elect to use a second processor-based system coupled to the first processor-based system, their profiles may be automatically forwarded to the second processor-based system. At the second processor-based system, those profiles may be automatically updated. Prior to powering down the second processor-based system, the user profiles may be transmitted back to the first processor-based system and stored thereon.

### BACKGROUND

This invention relates generally to sharing software between processor-based systems.

A variety of portable processor-based systems may provide computer functionality for specified applications. For example, a web tablet is a portable or battery powered device that may enable Internet access by communicating with a proximate host processor-based system that connects to the Internet. A personal digital assistant (PDA) may communicate with a host processor-based system to synchronize data such as schedules, calendars and the like. An MP3 player may similarly communicate with a host processor-based system to receive music files downloaded from the Internet by the host processor-based system. Portable processor-based systems may operate through a wired or wireless communication protocol with the host processor-based system.

The host processor-based system may be any of a variety of processor-based systems such as a set-top box, a laptop computer, a desktop computer, or an Internet appliance, as examples. Conventionally, the host receives electrical power from a wall outlet. A number of different users in a given user group, such as an office or family, may use the same host processor-based system.

Similarly, a number of different group members may use the portable processor-based system linked to the host processor-based system. For example, in connection with a web tablet, each user may access the Internet from locations around a facility. Each user may wish to maintain his or her own user profile.

The user profile is conventionally stored in a browser associated with a processor-based system. The profile may include information such as favorite web sites, web site access history, and cookies as a few examples. On the host processor-based system, when the user logs on with an identifier, his or her user profile may be activated. That profile may be continuously updated in the course of using the host processor-based system.

User profiles may be used with any application that envisions user personalized settings. Additional examples are electronic mail and MP3 player applications.

However, when the user uses a portable device linked to the host processor-based system, the user's profile is generally not accessible through the portable device. Moreover, any activities undertaken on the portable processor-based system may not be integrated into the user's profile on the host processor-based system.

Thus there is a need for better ways to share user profiles between processor-based systems.

### BRIEF DESCRIPTION OF THE DRAWINGS

FIG. 1 is a schematic depiction of one embodiment of the present invention;

FIG. 2 is a flow chart for the user manager software on the host device shown in FIG. 1 in accordance with one embodiment of the present invention;

FIG. 3 is a flow chart for the browser software on the portable device shown in FIG. 1 in accordance with one embodiment of the present invention;

FIG. 4 is a block depiction of the host and portable devices shown in FIG. 1 in accordance with one embodiment of the present invention; and

FIG. 5 is a front elevational view of a portable device in accordance with one embodiment of the present invention.

### DETAILED DESCRIPTION

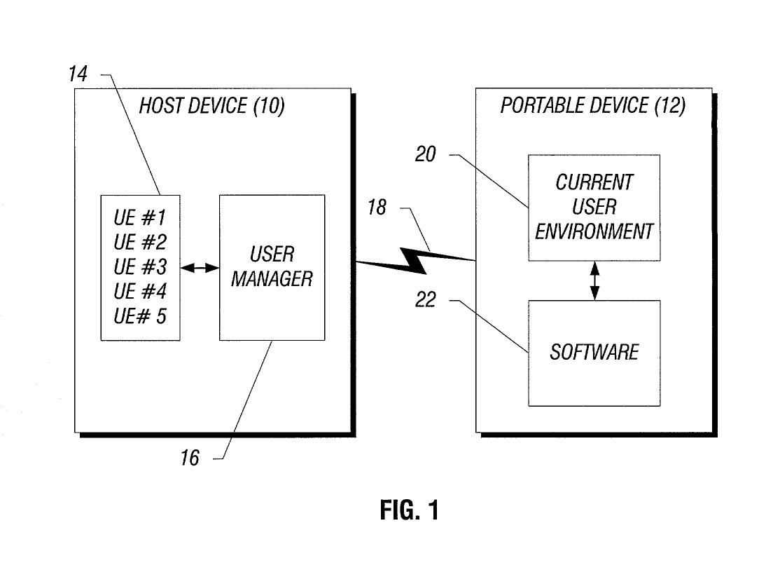

Referring to FIG. 1, a host processor-based system 10 may communicate with a portable processor-based system 12 via a link 18. While the link 18 may be a tethered or wire connection, it may also be a wireless connection such as a radio frequency link or infrared link as two examples. Commonly, the portable processor-based system 12 may be battery powered and the host processor-based system 10 may be connected to a source of electrical power as well as an Internet connection.

While embodiments of the present invention are discussed in conjunction with host and portable processor-based systems, the present invention is not limited to any particular types of processor-based systems. Embodiments may involve portable and non-portable processor-based systems. Embodiments may also include hierarchical and peer-to-peer relationships between linked processor-based systems.

The portable processor-based system 12 may access the Internet via the host processor-based system 10 and the link 18. The portable processor-based system 12 may be more convenient to use since it may be taken wherever the user may go so long as the portable processor-based system 12 is within the range of the particular link 18. This range may be relatively short with infrared or low power radio frequency links 18 and may be considerably greater in embodiments using a cellular telephone link 18.

The host processor-based system 10 may be any processor-based system including a desktop computer, a laptop computer, a set-top box, or a processor-based appliance to mention a few examples. The portable processor-based system 12 may be a web tablet, a personal digital assistant, an MP3 player, or a cellular telephone handset as a few examples.

The host processor-based system 10 may include a user manager 16 that manages the user profiles for a plurality of users. Each user profile may include a user environment which is separately maintained in a storage 14 on the host processor-based system 10. Each time the user undertakes activities, on the host processor-based system 10 associated with a particular software, those activities may be selectively recorded to develop a user profile that facilitates subsequent use of the host processor-based system 10. For example, the user profile may conventionally include cookies, favorite web sites, passwords, web site access history, temporary files, and user preferences, as a few examples.

Each time the user uses the host processor-based system 10, the user's profile may be updated in one embodiment. Upon completion of the user's activities on the host processor-based system 10, that profile may be updated and re-stored in a storage 14 under control of the user manager 16 in one embodiment.

When the user signs onto the host processor-based system 10 indicating that the user intends to operate the portable processor-based system 12, that user may provide an identifier which enables the user manager 16 to access that user's profile stored in the storage 14. The access may be provided by the user directly to the host processor-based system 10 by logging onto that system directly. Alternatively, the user may log onto the host processor-based system 10 using the portable processor-based system 12 over the link 18. In either case, the host processor-based system 10, upon recognizing the particular user, automatically provides the user's profile to the portable processor-based system 12 over the link 18.

In the course of using the portable processor-based system 12, the current user environment 20 is continuously updated by monitoring the user's activities on the user personalized software 22 that may be an application, such as a browser. Those updated activities may then be automatically transferred back to the host processor-based system 10, for example, prior to powering down the portable processor-based system 12.

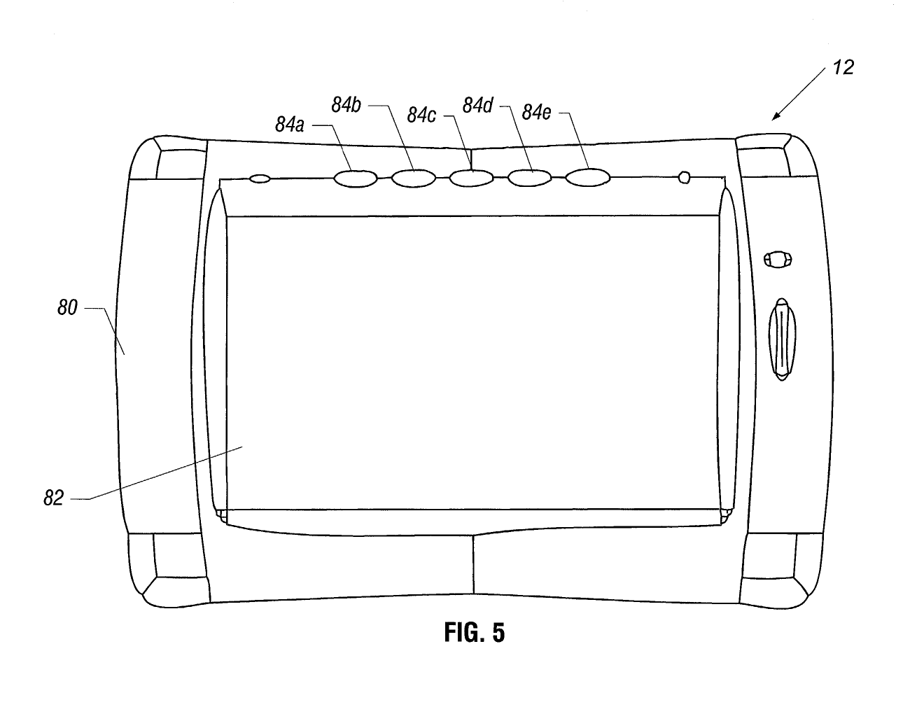

Referring to FIG. 5, in accordance with one embodiment, the portable device 12 may be a web tablet. The portable device 12, in this embodiment, includes a frame 80 that surrounds a display 82. A plurality of hardware buttons 84 may be aligned along the upper edge of the frame 30. Each of the buttons 84 may be assigned to a particular user. Thus, each of a plurality of users, in this embodiment five users, can use the portable device 12. Each user may recall his or her user environment by simply pressing an assigned button 84. Pressing the assigned button 84, in one embodiment, may also turn on the portable device 12. Thus, when the user selects the user's assigned button 84, the device 12 is turned on, the host processor-based system 10 immediately recognizes the user signing on, and provides the user environment to the portable device 12. A similar operation may be achieved using soft buttons assigned to each user as opposed to the illustrated hardware buttons 84.

Different users can use the same portable device 12 at different times and may access their own user environment in some embodiments of the present invention. In some embodiments of the present invention, users may use portable devices 12 rather than the host processor-based system 10. In other embodiments of the present invention, the users may utilize either system 10 or 12.

Particularly in situations where different software is utilized on the systems 10 and 12, it may be advantageous that the users' environments be developed solely through the use of the portable device 12 and not through the use of the host system 10. In other embodiments, software on each system 10 or 12 can exchange information sufficient to provide a unified user environment which may be transferred between different software on different systems 10 and 12.

In some embodiments of the present invention, a plurality of users of portable devices 12 may communicate with the same host processor-based system 10. Moreover, in such embodiments, it may not be necessary for one user to log out before another user logs in. Instead, the system may be utilized by a plurality of users each using separate portable devices 12. Moreover, each user may select any portable device 12 and may be able to access that user's user environment on any portable device 12 by the simple expedient of operating a hardware or software button or other selection operator.

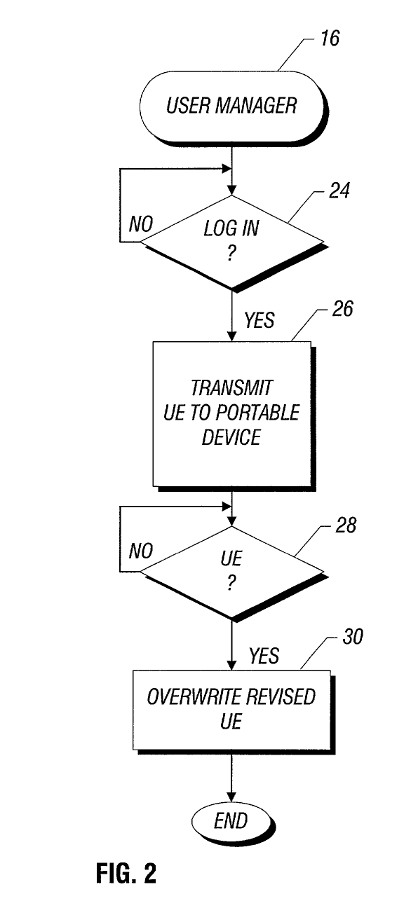

Turning next to FIG. 2, the user manager software 16, in accordance with one embodiment of the present invention, recognizes a login as indicated in diamond 24. In response to a login to the host processor-based system 10 that indicates that the user intends to use the portable processor-based system 12, the system 10 automatically creates a version of the identified user's user profile or environment for the portable processor-based system 12, as indicated in block 26. The version created may, in one embodiment, be a copy of the profile on the host processor-based system 10.

The host processor-based system 10 then monitors for the return of the user profile or environment from the portable processor-based system 12 as indicated in diamond 28. When it is received, the profile is used to overwrite the previously stored user profile or environment in the storage 14 as indicated in block 30.

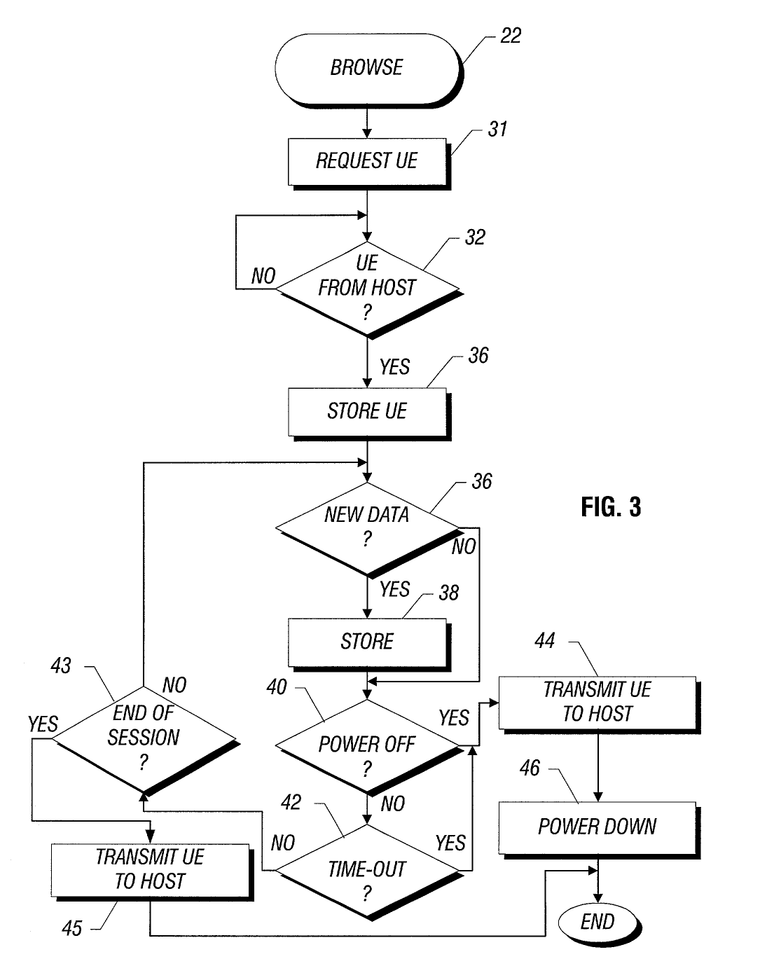

Referring now to FIG. 3, the browser software 22 on the portable processor-based system 12 may be responsible for handling the user environment or profile received from the host processor-based system 10 and for updating that profile based on the user's activities on the portable processor-based system 12. While the software 22 is illustrated as being part of the browser on the portable processor-based system 12, the software 22 may also be a non-browser application or other user personalized software.

The software 22 initially requests the user environment from the host processor-based system 10, as indicated in block 31. A check at diamond 32 determines whether the user profile or environment has been received from the host processor-based system 10. If so, it may be stored on the system 12 as indicated in block 34. As new data is developed based on the user's activities on the portable processor-based system 12, as determined in diamond 36, that new information may be stored locally on the system 12, as indicated in block 38.

A check at diamond 40 determines whether the user has elected to power down (reduce power consumption) the portable processor-based system 12. If so, the user profile or environment may be automatically transmitted to the host processor-based system 10 over the link 18 as indicated in block 44 in one embodiment. Only after transferring the user environment is the device powered down as indicated in block 46.

If there has been no selection of the power down feature, as determined in diamond 40, a check at diamond 43 determines whether a time out has been detected in one embodiment. A time out may be detected when the user fails to use the portable processor-based system 12 for a sufficient period of time. The time out may protect the battery from being unnecessarily drained. If the time out has occurred, the user environment is automatically transferred to the host processor-based system 10, as indicated in block 44, before powering down (block 46).

If no time out has occurred, a check at diamond 43 determines whether a given user session has been terminated. If so, the updated user environment is transferred to the host processor-based system 10, as indicated in block 45. Otherwise, the flow recycles to await new data to continue to build the user environment on the portable processor-based system 12.

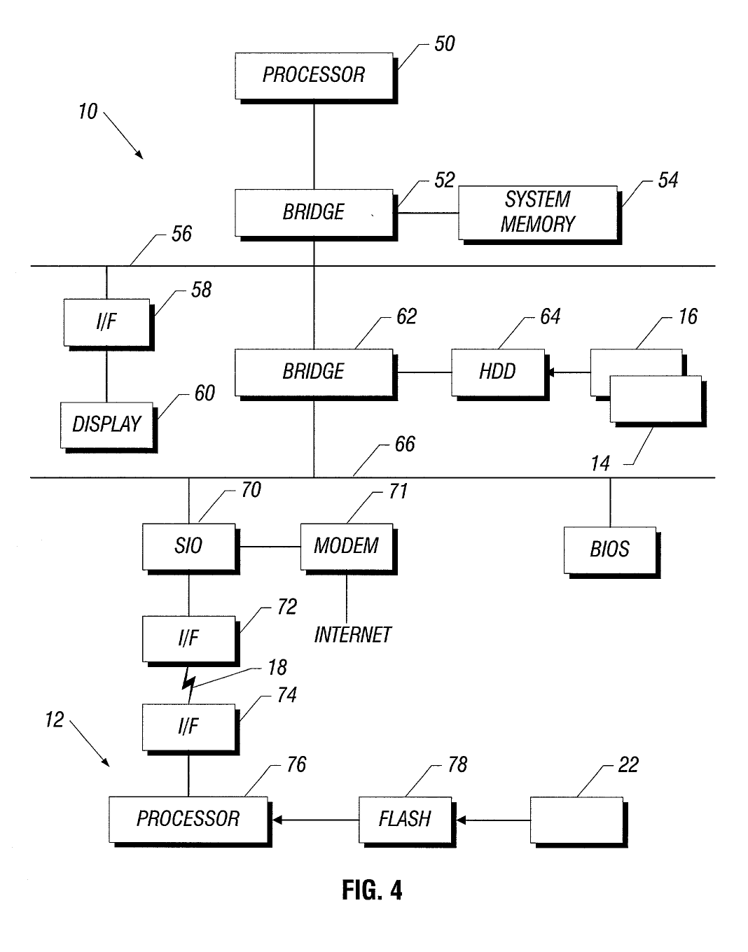

Finally, considering FIG. 4, the host processor-based system 10, in accordance with one conventional architecture, may include a processor 50 coupled to a bridge 52. The bridge 52, in this example, may be coupled to a system memory 54 and a bus 56. The bus 56 may communicate with an interface 58 and a display 60 as well as another bridge 62. Still in the same embodiment, the bridge 62 may communicate with a storage device such as a hard disk drive 64 that stores the user manager 16 and the user environment files.

The bridge 62 may in turn couple another bus 66. The bus 66 may be coupled to a basic input/output system (BIOS) storage 68 and a serial input/output (SIO) device 70. The device 70 may be coupled to an Internet interface such as a modem 71 and an interface 72 which may be a wireless interface in one embodiment of the present invention.

The interface 72 communicates over the link 18 with the portable processor-based system 12. The system 12 includes a similar interface 74 which is coupled to a processor 76. The processor 76 may in turn be coupled to a storage device such as a flash memory 78. The flash memory 78, in one embodiment of the present invention, may store the browser software 22.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
storing a user profile for each of a plurality of users on a first processor-based system; and
automatically creating a version of the profile for use on the second processor-based system.

2. The method of claim 1 including automatically creating a version of the profile in response to the user logging on to the first processor-based system.

3. The method of claim 2 including automatically creating a version of the profile for use on a portable processor-based system.

4. The method of claim 1 including automatically compiling a version of a user profile for a web browser session and storing said profile at the end of said web browser session.

5. The method of claim 1 including receiving an updated user profile from the second processor-based system.

6. A method comprising:
storing a profile for the current user of a second processor-based system;
updating said profile based on the current user's activities on the second processor-based system; and
automatically forwarding the updated profile to a first processor-based system.

7. The method of claim 1 including automatically forwarding the profile from the second processor-based system to the first processor-based system before powering down the second processor-based system.

8. The method of claim 6 wherein storing a profile includes automatically compiling a web browser profile based on activities of the user on the second processor-based system.

9. The method of claim 6 including automatically receiving said user profile from a first processor-based system.

10. The method of claim 9 further including automatically receiving said profile from said first processor-based system in response to a log on to said first processor-based system.

11. The method of claim 6 including automatically transmitting said user profile to a first processor-based system in response to a command to power down said second processor-based system.

12. An article comprising a medium storing instructions that enable a processor-based system to:
store a user profile for each of a plurality of users on the processor-based system; and
automatically create a version of the user profile for use on a second processor-based system.

13. The article of claim 12 further storing instructions that enable the processor-based system to automatically create the version of the profile in response to the user logging on to the processor-based system.

14. The article of claim 13 further storing instructions that enable the processor-based system to automatically create a version of a web browser profile in response to the user logging on to the processor-based system through the second processor-based system.

15. The article of claim 12 further storing instructions that enable the processor-based system to automatically compile a version of the user profile for a web browser session and store said profile at the end of said web browser session.

16. The article of claim 12 further storing instructions that enable the processor-based system to receive an updated user profile from a second processor-based system.

17. An article comprising a medium storing instructions that enable a second processor-based system to:
store a user profile for the current user of the second processor-based system;
update said profile based on the current user's activities on the second processor-based system; and
automatically forward the updated profile to a first processor-based system.

18. The article of claim 17 further storing instructions that enable the second processor-based system to automatically forward the profile before powering down the portable processor-based system.

19. The article of claim 17 further storing instructions that enable the second processor-based system to automatically create a version of a web browser profile based on activities of the user on the second processor-based system.

20. The article of claim 17 further storing instructions that enable the second processor-based system to automatically receive said updated profile from a first processor-based system.

21. The article of claim 20 further storing instructions that enable the second processor-based system to automatically receive a web browser profile from the first processor-based system in response to a log on to the first processor-based system.

22. The article of claim 17 further storing instructions that enable the second processor-based system to automatically transmit the updated profile to a first processor-based system in response to a command to power down the second processor-based system.

23. A system comprising:
a processor; and
a storage coupled to the processor, the storage storing instructions that enable the processor to store a web browser profile for each of the plurality of users of the system and automatically provide the web browser profile for a user to a second processor-based system.

24. The system of claim 23 including a wireless interface to communicate with the second processor-based system.

25. A system comprising:
a processor; and
a storage coupled to the processor, the storage storing instructions that enable the processor to store a web browser profile for the current user of the system, update the profile based on the current user's activities on the system, and automatically forward the updated profile to a second processor-based system.

26. The system of claim 25 wherein said system is a battery powered system.

27. The system of claim 25 wherein said system communicates with said second processor-based system using a wireless interface.

28. The system of claim 25 wherein said storage stores instructions that enable the processor to automatically compile a web browser profile based on activities of the user on the system.

29. The system of claim 25 wherein said storage stores instructions that enable the processor to automatically transmit said web browser profile to the second processor-based system in response to a command to power down the processor-based system.
